(19) United States
(12) Patent Application Publication
(10) Pub. No.: US 2019/0059408 A1
(43) Pub. Date: Feb. 28, 2019

(54) CHEESE PRODUCT WITH MODIFIED STARCHES

(71) Applicant: Cargill, Incorporated, Wayzata, MN (US)

(72) Inventors: Fabien BOURON, Saint Gilles (FR); Dirk FONTEYN, Bonheiden (BE); Joseph L. KLEMASZEWSKI, Plymouth, MN (US); Laurence LEMONNIER, Montgardon (FR)

(21) Appl. No.: 15/575,900

(22) PCT Filed: Apr. 11, 2016
(86) PCT No.: PCT/US2016/026877

§ 371 Date: Nov. 21, 2017

Related U.S. Application Data
(60) Provisional application No. 62/168,213, filed on May 29, 2015.

(51) Int. Cl. A23C 20/00; A23L 29/212

(52) U.S. Cl. CPC A23C 20/00; A23L 29/212

(57) ABSTRACT

Described is a cheese product with modified starches. The cheese product comprises less than 25 wt. % modified starch selected from corn-derived modified starch, tapioca-derived modified starch, sago-derived modified starch, or combinations thereof. The cheese product has similar shred, firmness, flowability, stretch, and hardness characteristics compared to a cheese product comprising potato-derived modified starch.

### CROSS-REFERENCE TO RELATED APPLICATION

This non-provisional application claims the benefit of commonly owned provisional application having Ser. No. 62/168,213, filed on May 29, 2015, entitled CHEESE PRODUCT WITH MODIFIED STARCHES, which is incorporated herein by reference in its entirety.

### BACKGROUND

Modified potato starches may be used in cheese analogue and cheese process products because these particular starches typically have a low gelatinization temperature and an ability to form firm gels without restricting the melt properties of the cheese product. Traditional modified corn starches may require a higher heating temperature compared to modified potato starches and corn starches may restrict the melt properties of the cheese products. It would be desirable to have modified corn-derived, tapioca-derived, and/or sago modified starches that may be used with both cheese analogue and cheese process products for at least the reasons that such corn, tapioca, and sago starches may have better availability and lower price than modified potato starch.

### SUMMARY

The present invention uses thinned, substituted and/or modified starches derived from corn, tapioca, and/or sago, either alone or in combination, to give functionality similar to potato-derived starches in analogue and process cheese products. In one embodiment, the present invention provides a cheese analogue product comprising less than 25 wt. % modified starch selected from the group consisting of corn-derived modified starch, tapioca-derived modified starch, sago-derived modified starch, or combinations thereof, wherein the cheese analogue product has similar shred, firmness, melt and stretch characteristics compared to a cheese analogue product comprising potato-derived modified starch.

In some embodiments, the modified starch is a corn-derived modified starch such as waxy corn starch or modified dent corn starch. In still other embodiments, the modified starch is an acid thinning corn starch or an n-octenylsuccinic anhydride modified corn starch. In alternative embodiments, the modified starch is a tapioca-derived modified starch.

The cheese analogue products of this invention may be further characterized by stretch, shred, flowability, firmness, or hardness characteristics that are determined or measured as described below. Suitable stretch characteristics are in a range of about 60-100 cm when determined by the process illustrated in attached FIG. 5. Suitable shred characteristics are qualitatively determined from visual observation of a cheese analogue products shred length, clumping, and amount of cheese fines. Examples of acceptable and unacceptable shred characteristics are illustrated in attached FIG. 6. Suitable flowability characteristics are in a range of about 20-60% when determined by the process illustrated in attached FIG. 7. Suitable firmness characteristics are in a range of about 150-350 grams/mm when determined by the process illustrated in attached FIG. 8. Suitable hardness characteristics are greater than 6 kg when determined by the process illustrated in FIG. 9.

Another embodiment of the present invention is a method of making a cheese analogue product comprising the step of substituting at least some of the potato starch of a cheese product with less than 10 wt. % modified starch selected from the group consisting of corn-derived modified starch, tapioca-derived modified starch, sago-derived modified starch, or combinations thereof.

Still another embodiment of the invention is a method of making a cheese analogue product using a cooker comprising the steps of: a) adding rennet casein, citric acid and less than 10 wt. % modified starch selected from the group consisting of corn-derived modified starch, tapioca-derived modified starch, or combinations thereof to water to provide a water/starch solution, b) adding vegetable fat to the water/starch solution to provide a water/fat mixture, c) adding melting salts to the water fat/mixture to provide a cheese mixture, d) cooking the cheese mixture at a temperature of about 62-85° C. (for example, 70-78° C.) for a time of about 5-20 minutes to provide an emulsified cheese product, e) holding the emulsified cheese product at a temperature of about 76° C. for 2-5 minutes, and f) and cooling down the cheese in a water bath.

A suitable apparatus used in these methods may be a twin screw cooker and the cheese mixture is cooked via direct steam injection at a temperature of about 62-85° C. (for example, 70-78° C., or for example 76° C.) to form the emulsified cheese product. When a twin screw cooker is used, for example, and the process comprises the steps of a) adding dry ingredients such as rennet casein, starch, citric acid, and sodium chloride to water, to provide a dry ingredients mixture, b) adding vegetable fat to the dry ingredients mixture to provide a vegetable fat mixture, c) adding melting salts to the vegetable oil mixture to provide a pre-emulsion, d) cooking the pre-emulsion at an elevated temperature to provide a heated emulsion, e) holding the heated emulsion at a predetermined elevated temperature for a predetermined time and then hot filing the heated emulsion, and f) cooling the filled emulsion.

Yet another embodiment of the present invention is a food product comprising the cheese analogue product as described above. In some embodiments, the food product is a pizza.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides comparative emulsification times for different cheese analogue products.

FIG. 2 provides comparative flowability properties for different cheese analogue products.

FIG. 3 provides comparative stretch properties for different cheese analogue products.

FIG. 4 provides comparative firmness properties for different cheese analogue products.

FIG. 5A-B is a digital image showing the process of measuring the stretch characteristics of the cheese product described in this disclosure. Stretch characteristics of a cheese analogue product may be evaluated by heating 90 g of shredded or grated cheese to 240° C. for 6 minutes in an aluminum container. FIG. 5B shows the stretch evaluation as conducted between 78° C. and 83° C.

FIG. 6A-C is a digital image showing an exemplary cheese shred properties. FIG. 6A shows longer shreds, more free flowing and less clumps. FIG. 6C shows shorter shreds, more fines and clumping.

FIG. 7A-C is a digital image showing the flowability or melt characteristics of a cheese analogue product evaluated using the Schreiber method. The Schreiber melt test involved placing a cylinder of cheese approximately 35 mm (1⅜ inches) in diameter and 0.5 cm ( 3/16-in.) in a glass petri dish, heating it in an oven at 200° C. for 10 minutes. FIG. 5B shows that cheese melting as measured using the melted distance travel on the 14 axis defined on the gauge.

FIG. 8A-B shows a method of measuring gel strength using a texture analyzer. FIG. 8B shows a graphical representation of firmness as the slope between 2.5 and 5 mm in g mm. Brittleness of the cheese depends on strength (in g) and distance (in mm) (2a and 2b).

FIG. 9A-B shows a digital image of measuring cheese hardness. Hardness is the force necessary to compress a 25 mm cheese cube to half of its height.

### DETAILED DESCRIPTION

A cheese analogue product is a product used as a replacement for cheese in food products. Cheese analogue products may include vegan cheese alternatives and other processed products. One variant of cheese analogue products are designed to melt well on pizza, while also remaining chewy. Cheese analogue products may be formulated for processing with basic cheese-making equipment and processing that Mozzarella cheese requires, such as for the processes of mixing and molding. Cheese analogue products also may be made using process cheese making equipment, which may not include a mixer molder. Most cheese analogue products have a soft texture when melting and have a stringy quality when pulled.

Analogue cheese products are generally described as products that look like cheese, but in which constituents including milk fat have been partly or completely replaced by other ingredients. Codex Alimetarious Commission, 1995 describes analogue cheese products as products that look like cheese in which milk fat has been replaced by other fats. Analogue cheeses vary from each other based on flavor, nutritional values, functionality, and in their applications. Many flavors of analogue cheese are found in the market, including American, Cheddar, and Monterrey Jack, and can be purchased in blocks, shreds, slices, or sauces. Other categories of analogue cheeses are available as blends with cheese products. New technologies in manufacturing analogue cheese products make these products available to the fast growing vegetarian and vegan consumer market. Manufacturers are looking into cheese analogues as a cost effective alternative to cheese.

Analogue cheese generally refers to a cheese in which milk fat and/or a protein source has been substituted with a source that is not native to milk. Analogue cheeses are typically lower in cost than other cheese types because the processing can be performed less expensively and because certain milk ingredients can be substituted with cost effective food ingredients (e.g., substituting vegetable oil for milk fat). The health benefits derived from substitution of the saturated milk fat with other less saturated alternatives and the ability to add other ingredients that can improve the nutritional characteristics of the final product.

Analogue cheeses are typically categorized based on their source of fats and proteins. If the source of all fats and proteins come from dairy sources, it is referred to as “process cheese products”. If some fats and proteins come from dairy sources, while other have been replaced with non-dairy fats and proteins, these are referred to as partial dairy or if all fats and/or proteins come from non-dairy sources, these are referred to as nondairy. Analogue cheese is typically categorized as partial dairy or nondairy. They can also be classified as being an imitation cheese or a substitute cheese. Imitation cheese is a substitute for and resembles another cheese. Compared to natural cheese, both imitation cheese and analogue cheese may be preferred nutritionally (based on fatty acid profiles), may be equal nutritionally if the imitation/analogue is a substitute cheese, or may be less preferred nutritionally in some cases. A cheese substitute, on the other hand, resembles other cheeses but has a minimum required protein level.

A “cheese analogue” as used herein refers generally to a cheese-like product manufactured using starches as a primary structure building ingredients. Cheese analogues described herein may belong to “nondairy” category and exhibit shred quality, melt, stretch similar to that of cheese, and may ooze oil and make blisters when heated on pizza. These imitation cheeses can be converted into cheese substitutes by incorporating nutrients at desired levels without affecting their cheese-like functionality.

Meltability refers to the ability of cheese to soften to a molten cohesive mass on heating. Flowability refers to the ability of the melted cheese to flow. Stretchability refers to the ability of the melted cheese to form cohesive fibers, strings, or sheets when extended uniaxially. Flow resistance refers to the resistance to flow of melted cheese. Chewiness (rubbery, tough, and elastic) refers to the high resistance to breakdown upon mastication. Viscous (soupy) refers to the low resistance of melted cheese to breakdown upon mastication. Desirable surface appearance refers to the desired degree of surface sheen with few, if any, dry, black scorched or brown scorched particles.

Corn is a major source of product for the milling, both dry and wet, industry. Principal products of dry milling include, for example, grits, meal and flour. The principal products of wet milling include, for example, starch, fiber, corn syrup and dextrose. Corn oil recovered from the corn germ is a by-product of both dry and wet milling. Industrial and food applications of wet milling products of corn are based on the general functional and intrinsic properties of corn, such as viscosity, film formation, adhesive properties, taste, protein levels and starch types.

One of these milling products, starch, is comprised of two polymers (polysaccharides), amylose and amylopectin. In particular, starch derived from dent or flint corn is composed of approximately 73% amylopectin and 27% amylose, each of which does not exist free in nature, but as a component of a discrete, semi-crystalline aggregate, called starch granules. Amylose is an essentially linear polymer composed almost entirely of α-1-4 linked D-glucopyranose. Although typically illustrated as a straight chain structure for the sake of simplicity, amylose is actually often helical. The interior of the helix contains hydrogen atoms and is therefore hydrophobic, allowing amylose to form a type of clathrate complex with free fatty acids, fatty acid components of glycerides, some alcohols and iodine. Amylopectin, the predominant molecule in most starches is a branched polymer that is much larger than amylose. Amylopectin is composed of α-1-4 linked glucose segments connected by α-1-6 linked branch points.

Modified Starches

All starches and flours (hereinafter “starch”) may be suitable for use herein and may be derived from any native source. A native starch or flour as used herein, is one as it is found in nature. Also suitable are starches and flours derived from a plant obtained by standard breeding techniques including crossbreeding, translocation, inversion, transformation or any other method of gene or chromosome engineering to include variations thereof. In addition, starch or flours derived from a plant grown from artificial mutations and variations of the above generic composition which may be produced by known standard methods of mutation breeding are also suitable herein.

Typical sources for the starches and flours are cereals, tubers, roots, legumes and fruits. The native source can be corn, pea, potato, sweet potato, banana, barley, wheat, rice, sago, amaranth, tapioca, arrowroot, canna, sorghum, and waxy or high amylose varieties thereof. A used herein, the term “waxy” is intended to include a starch or flour containing at least about 95% by weight amylopectin and the term “high amylose” is intended to include a starch or flour containing at least about 40% by weight amylose.

Conversion products derived from any of the starches, including fluidity or thin-boiling starches prepared by oxidation, enzyme conversion, acid hydrolysis, heat and or acid dextrinization, and/or sheared products may also be useful herein.

Chemically modified starches may also be used. Such chemical modifications are intended to include without limitation cross-linked starches, acetylated and organically esterified starches, hydroxyethylated and hydroxypropylated starches, phosphorylated and inorganically esterified starches, cationic, anionic, nonionic, and zwitterionic starches, thinned starches (such as acid and enzymatic thinned starches), and succinate and substituted succinate derivatives of starches. Such modifications are known in the art, for example in Modified Starches: Properties and Uses, Ed. Wurzburg, CRC Press, Inc., Florida (1986).

Modified starches may be used to make cheese analogue products. The octenylsuccinate derivatives are preferred when better emulsifying properties are required. One of skill would recognize that the emulsifying properties required will depend not only on the oil content of the cheese product but the amount of casein protein in the formula, with the octenylsuccinate derivative being preferred for protein levels below 15% in the cheese product. Their use will prevent unacceptable oil loss during preparation of the cheese and undesirable oiling-off on the surface of the final cheese product. Some oiling-off in the melted cheese is desirable. The most preferred modified starch derivative for use in a cheese formulation is a cook up waxy corn starch derivative, substituted with up to 3% octenyl succinic anhydride, preferably with 1% octenyl succinic anhydride, that has undergone thinning by acid and/or enzymes.

Modified tapioca starch may also be used as a cheese analogue product. The term “tapioca” is commonly used to refer to both the tapioca (or cassava) plant and the granular starch that is extracted from the tapioca plant. The tapioca plant is a member of the Euphorbiaceae or spurge family, manihot genus. Tapioca starch in granular form has been traditionally used in puddings and as a thickener in liquid foods. It is considered to have a very mild flavor and to be suitable for hypoallergenic foods. The tapioca starch is obtained from the tuberous root of the tapioca plant.

In some embodiments, a cheese analogue product may be made using a cooker. Rennet casein, citric acid, and less than 10 wt. % modified starch selected from corn-derived modified starch, tapioca-derived modified starch, sago-derived modified starch or combinations were added to the cooker to provide a water and starch solution. Next, vegetable fat was added to the water and starch solution to provide a water and fat mixture. Then, melting salts were added to the water and fat mixture to provide a cheese mixture. The cheese mixture was cooked at a temperature of about 62° C. to 85° C., preferably 70° C. to 78° C. for about 5-20 minutes to provide an emulsified cheese product. After cooking, the emulsified cheese product is held at a temperature for 2 to 5 minutes, and then the emulsified cheese product is hot filled.

In other embodiments, a cheese analogue product may be made using a twin screw cooker. In a twin screw cooker the process includes the sequential steps of: a) rennet casein, starch, citric acid, and sodium chloride are added to water, to provide a dry ingredients mixture, b) vegetable fat is added to the dry ingredients mixture to provide a vegetable fat mixture, c) melting salts are added to the vegetable oil mixture to provide a pre-emulsion, d) the pre-emulsion is cooked in the twin screw cooker at 76° C. to provide a heated emulsion, e) the heated emulsion is held at 76° C. for 3 minutes and then hot filed and then f) then the hot filled emulsion is cooled in a water bath.

Cheese Product Characteristics

Emulsification times of a cheese analogue product determine product throughput during the production of the cheese analogue product. Lower emulsification times that provide higher throughput rates during processing are advantageous due to the increase in product production. Preferred emulsification times of the cheese analogue products of this disclosure are in a range of about 10-14 minutes and may provide about a 10% increase in throughput when compared to cheese analogue products with emulsification times greater than about 14 minutes.

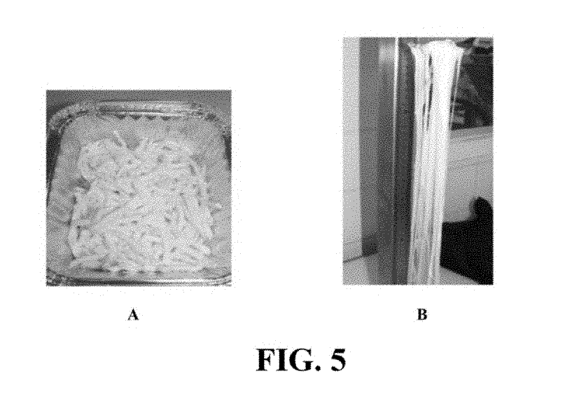

Stretch characteristics of a cheese analogue product may be evaluated by heating 90 g of shredded cheese to 240° C. for 6 minutes in an aluminum container. The stretch evaluation was conducted between 78° C. and 83° C. Elasticity refers to the amount of resistance offered by the cheese strands as they are stretched. Preferred stretch characteristic values for the cheese products of this disclosure are about 60-100 cm in a higher protein sample and greater than 25 cm in a reduced protein, higher fat sample. The process of measuring the stretch characteristics of the cheese product described in this disclosure is illustrated in FIG. 5.

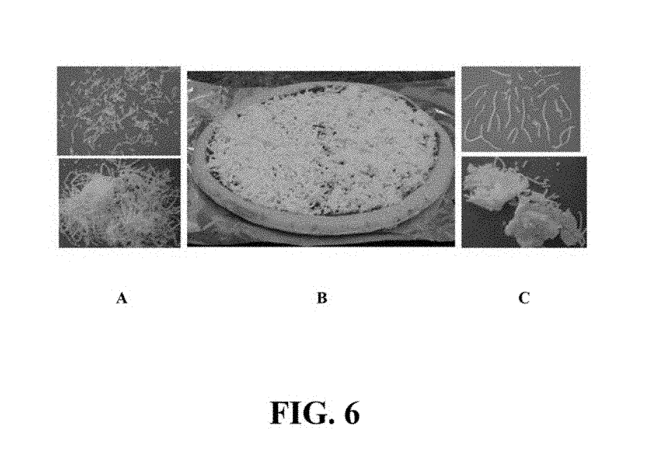

Shred characteristics include long shreds, short shreds, and fines. Shred dimensions include length and width. Visual shred characteristics include straightness, roughness, and wetness. Other shred characteristics include firmness and adhesiveness. Suitable shred characteristics may be qualitatively determined, for example, from visual observation of a cheese analogue products shred length, clumping, and amount of cheese fines. Examples of acceptable and unacceptable shred characteristics are illustrated in FIG. 6.

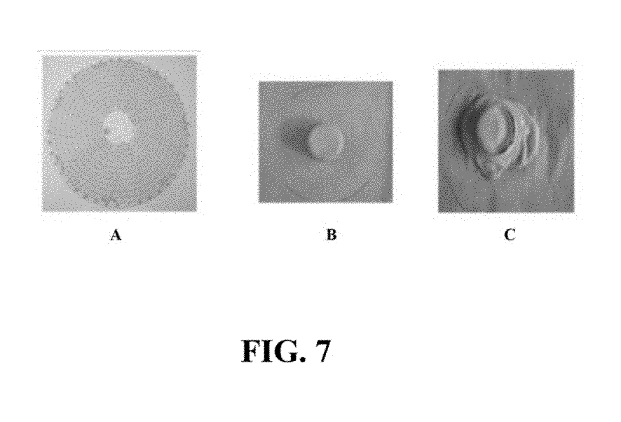

The flowability or melt characteristics of a cheese analogue product may be evaluated using the Schreiber method. The Schreiber melt test involves placing a cylinder of cheese approximately 35 mm (1⅜ inches) in diameter and 0.5 cm ( 3/16-in.) in a glass petri dish, heating it in an oven at 232° C. (450° F.) for 5 minutes, and then cooling it for 30 minutes. The results are read over a concentric-numbered, target-type graph. Flowability is expressed as the average percentage increase in radius as measured along 14 equally spaced axes. Preferred flowability values of the cheese analogue products of this invention are in a range of about 20-60%. The process of measuring the flowability or melt characteristics of the cheese analogue products described in this disclosure is illustrated in FIG. 7.

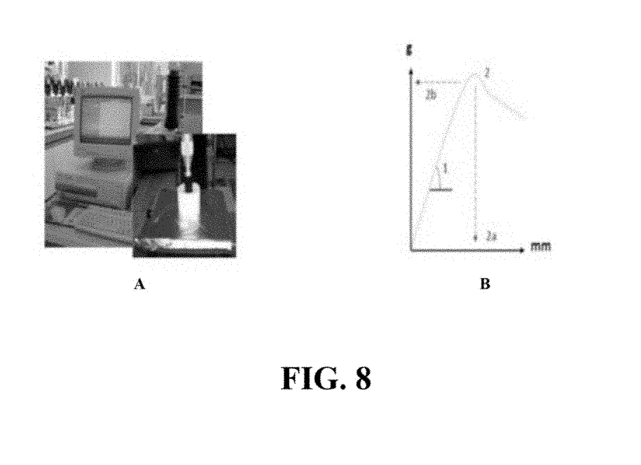

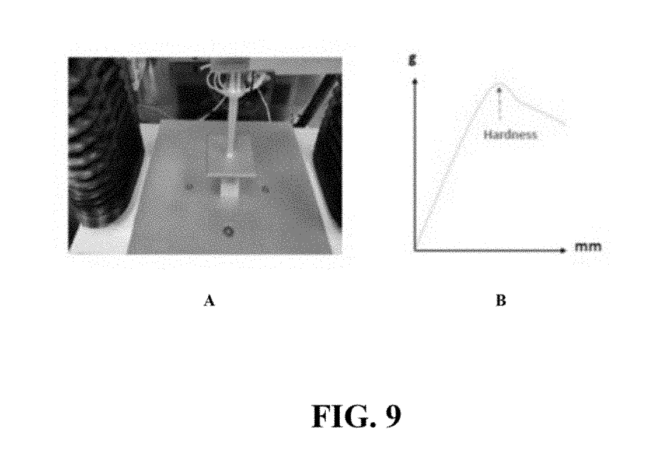

The gel strength or hardness of a cheese analogue product may be evaluated using a texture analyzer. A suitable analyzer, for example is a TA.XT2i texture analyzer (Texture Technologies Corp., Hamilton, Mass.). The texture analyzer can measure texture, quantify hardness, brittleness, fracturability, adhesiveness, stiffness, elasticity, and Bloom strength. These measurements provide processes to determine if a cheese product has acceptable firmness characteristics. The firmness and brittleness of the cheese analogue was typically tested at 5° C. Preferred firmness characteristic values for the cheese analogue product of this disclosure are in a range of about 150-350 grams/mm. The method of measuring the firmness characteristics of the cheese analogue products of this disclosure is illustrated in FIG. 8. Hardness is determined by the force necessary to compress a 1 inch (26 mm) cube of cheese to 50% of its original height. Preferred hardness values are 6 kg or higher. An illustration of this method is shown in FIG. 9.

### Example 1

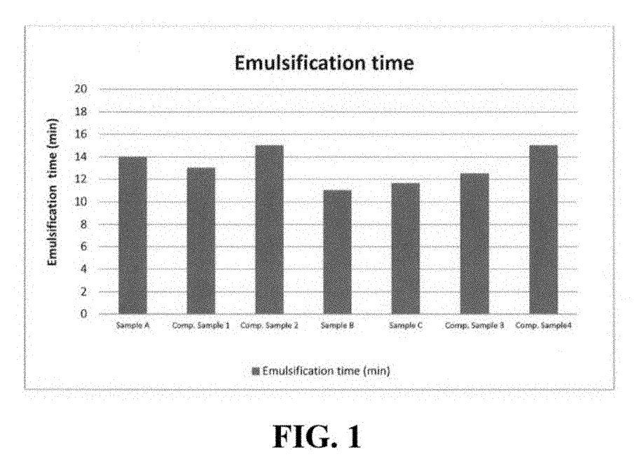

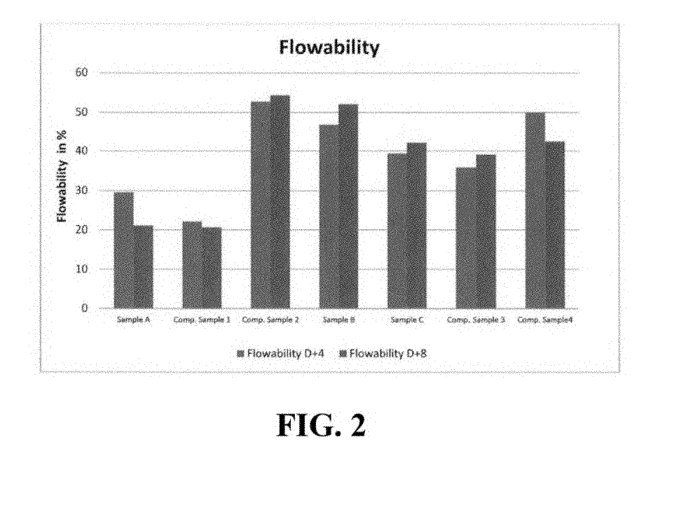

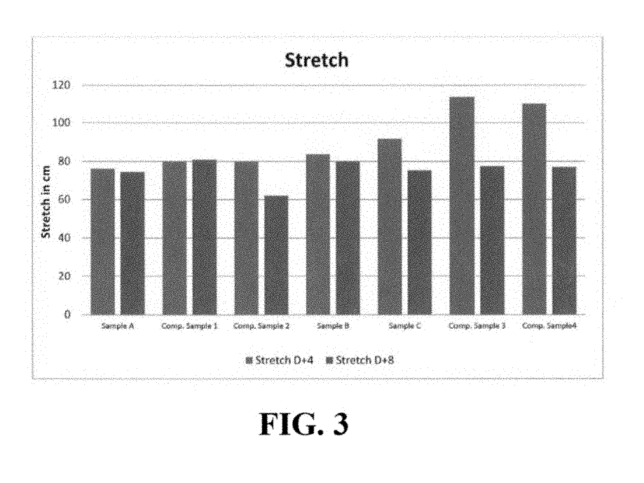

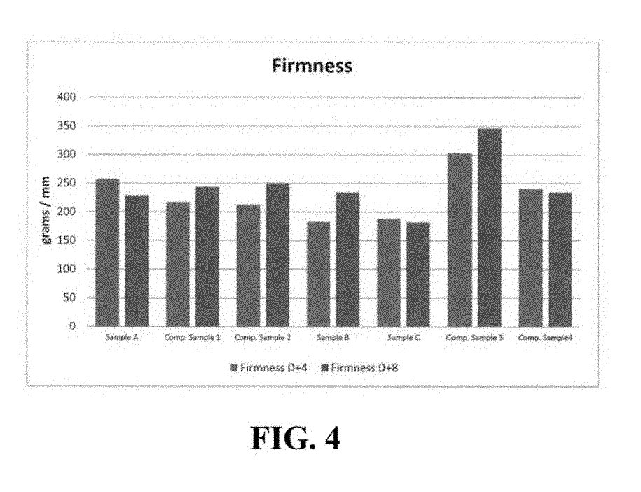

In this example, cheese analogue products were made with modified dent corn, modified waxy corn, and with commercially available modified potato starches. The characteristics of the resulting cheese analogue products were evaluated and compared. The comparative test results are listed in FIGS. 1-4.

The starches used in this experiment are granular cook-up starches based on different starch origin: dent corn starch, waxy corn starch, or potato starch. Typically, the starches are slurried and hydrolyzed (acid thinned or thin boiled) by hydrochloric acid addition. Subsequently, these thinned starches are modified by chemical modification. All starches were subsequently washed and dried.

The cheese analogue products with a substituted starch include the following ingredients compared to cheeses made with modified potato starches.

| Ingredient | Percentage |
|---|---|
| Water and Condensate | 53 |
| Rennet Casein | 17.2 |
| Vegetable Fat | 22.2 |
| Starch | 5 |
| Citric Acid | 0.3 |
| NaCl | 1.1 |
| Melting Salts | 1.2 |

In an example, dent corn starch was hydrolyzed with hydrochloric acid in three different hydrolysis levels. The dent corn starch was subsequently modified with 1-3.4% n-octenylsuccinic anhydride.

In another example, waxy corn starch was hydrolyzed with hydrochloric acid to different hydrolysis levels and was subsequently modified with 1% n-octenylsuccinic anhydride.

Potato starch, for example, was hydrolyzed with hydrochloric acid to different hydrolysis levels, and subsequently modified with 1-3.4% n-octenylsuccinic anhydride or with acetic anhydride up to a maximum of 2.5% bound acetyl. Further tests were conduct on potato starch that was slurried and hydrolyzed by hydrochloric acid addition and subsequently modified by 1.4% acetic anhydride, washed, and dried. Additional samples of modified potato starches commercially available were also evaluated.

Based on extensive application tests in pizza cheese applications, specifically towards their functionality to provide stretch, melt and shred quality, three starches were selected for further evaluation as described below.

Sample A (C*Stretch 05064): Dent corn starch that was slurried and hydrolyzed by hydrochloric acid addition, and then washed and dried.

Sample B (C*Stretch 06392): Waxy corn starch that was slurried and hydrolyzed by hydrochloric acid addition, and then subsequently modified by 1.0% n-octenylsuccinic anhydride, washed and dried.

Sample C (C*Stretch 06392/C*Stretch 05064—70/30 wt. % blend): Blend of two corn starches described above.

The test results for Samples A, B, and C are listed in FIGS. 1-4. FIGS. 1-4 also list test results for Comparative Samples 1, 2, 3, and 4. Comparative Samples 1, 2, 3, and 4 were commercially available modified potato starches. Comparative Sample 1 was modified potato starch E1420 (KMC, Brande, Denmark), Comparative Sample 2 was modified potato starch E1422 (KMC, Brande, Denmark), Comparative Sample 3 was modified potato starch Perfectamyl Gel EMP (AVEBE, Veendam, the Netherlands), and Comparative Sample 4 was modified potato starch E1420 (Cargill Inc., Minneapolis, Minn.).

### Example 2

In this example analogue cheese products were made using a commercially available modified potato starch as a control and improved products made with modified starch and/or modified starch blends based on corn and/or tapioca which have a lower cost.

| 2.1 Analogue Cheese Formula | % |
|---|---|
| Rennet casein, 90 mesh | 16.0 |
| Salt | 1.7 |
| Water | 35.3 |
| Steam condensate | 11.5 |
| Palm Oil, 100° F. melt | 25.0 |
| Starch (see table 2.2 below) | 8.0 |
| Sodium aluminum phosphate (basic) | 1.4 |
| Trisodium citrate | 0.9 |
| Citric acid | 0.2 |
| Total | 100 |

| 2.2 Starch and starch | |
|---|---|
| blends | Description |
| Control | 100% Thinned and substituted potato starch |
| Starch Blend 2A | 75% PolarTex ® 05732 - HP substituted and |
| | cross-linked dent corn starch |
| | 25% Accubind ™ 12675 - thinned and nOSA |
| | substituted waxy corn starch |
| Starch Blend 2B | 58% PolarTex ® 05732 - substituted and |
| | cross-linked dent corn starch |
| | 42% CRD 3037 - substituted pyrodextrin from |
| | dent corn starch |
| Starch Blend 2C | 58% PolarTex ® 05732 - substituted and |
| | cross-linked dent corn starch |
| | 42% Cargill Plus ™ 07701 - pyrodextrin from |
| | dent corn starch |
| Starch 2D | 100% C*Stretch 06392 - thinned and nOSA |
| | substituted waxy corn starch |
| Starch Blend 2E | 58% PolarTex ® 05732 - substituted and |
| | cross-linked dent corn starch |
| | 42% CRD 2961 - thinned and nOSA |
| | substituted dent corn starch |

These analogue cheeses were made using a twin screw cheese cooker and aged a minimum of 5 days before evaluating. Tests included firmness, modified Schreiber melt, and stretch. The firmness and stretch tests have been previously described. The melt test used is a modification of the flowability and melt described in FIG. 7. In this example, cheese discs having diameter of 22.5 mm (0.9 inches) and weight of 6.5 grams were melted on a dish in an oven where the temperature used was 232° C. for 6 minutes. After melting and cooling the surface area of the melted cheese was calculated and the corresponding mean radii determined, which was converted to the flowability values as shown in FIG. 7. The results for these analogue cheeses are shown in Table 2.3.

Table 2.3 Characteristics of analogue cheeses made with control modified potato starches and improved alternatives.

| Starch ID | Firmness (kg) | Flowability | Stretch (cm) |
|---|---|---|---|
| Control | 5.9 | 36% | 14.5 |
| Starch Blend 2A | 6.5 | 52% | 26.0 |
| Starch Blend 2B | 7.4 | 49% | 28.0 |
| Starch Blend 2C | 3.5 | 50% | 24.5 |
| Starch 2D | 10.6 | 69% | 35.0 |
| Starch Blend 2E | 6.4 | 45% | 15.0 |

In this example, Starch Blend 2E had properties closest to the control and was slightly superior in the attributes tested. Starch Blend 2A, Starch Blend 2B, and Starch 2D tested significantly better in these attributes than the control modified potato and along with their lower cost, highlight the improvements of this invention. Starch Blend 2C was inferior to the control in terms of firmness and did not make an acceptable cheese. A key difference between Starch Blend 2B and Starch Blend 2C is the nOSA substitution of pyrodextrin is present in the Starch Blend 2B and not in Starch Blend 2C.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A cheese analogue product comprising less than 25 wt. % modified starch selected from the group consisting of corn-derived modified starch, tapioca-derived modified starch, sago-derived modified starch, or combinations thereof, wherein the cheese analogue product has similar shred, firmness, melt and stretch characteristics compared to a cheese analogue product comprising potato-derived modified starch.

2. The cheese analogue product of claim 1, wherein the modified starch is a corn-derived modified starch.

3. The cheese analogue product of claim 1, wherein the modified starch is waxy corn starch.

4. The cheese analogue product of claim 1, wherein the modified starch is dent corn starch.

5. The cheese analogue product of claim 1, wherein the modified starch is a tapioca-derived modified starch.

6. The cheese analogue product of claim 1, wherein the modified starch is a sago-derived modified starch.

7. The cheese analogue product of claim 1, wherein the modified starch comprises octenylsuccinic anhydride substituted starch or starches with a maximum n-octenylsuccinyl level of 3.0% bound to the starch.

8. The cheese analogue product of claim 7, wherein viscosity of the modified starch is reduced by acid, enzymes, chlorine, peroxide treatment, or a combination thereof.

9. The cheese analogue product of claim 1, wherein the modified starch comprises acetic anhydride substituted starch or starches with a maximum acetyl level of 2.5% bound to the starch.

10. The cheese analogue product of claim 9, wherein the viscosity of the modified starch is reduced by acid, enzymes, chlorine, peroxide treatments, or a combination thereof.

11. The cheese analogue product of claim 1, comprising less than 15 wt. % modified starch.

12. The cheese analogue product of claim 1, comprising between about 2 wt. % and 10 wt. % modified starch.

13. A cheese product comprising between 2% and 10 wt. % modified starch selected from the group consisting of corn-derived modified starch, tapioca-derived modified starch, sago-derived modified starch, or combinations thereof, wherein the cheese analogue product has similar shred, firmness, melt and stretch characteristics compared to a cheese analogue product comprising potato-derived modified starch.

14. The cheese product of claim 13, wherein the modified starch is a corn-derived modified starch.

15. The cheese product of claim 13, wherein the modified starch is waxy corn starch.

16. The cheese product of claim 13, wherein the modified starch is dent corn starch.

17. The cheese product of claim 13, wherein the modified starch is a tapioca-derived modified starch.

18. The cheese product of claim 13, wherein the modified starch is a sago-derived modified starch.

19. The cheese product of claim 13, wherein the modified starch comprises octenylsuccinic anhydride substituted starch or starches with a maximum n-octenylsuccinyl level of 3.0% bound to the starch.

20. The cheese product of claim 19, wherein the viscosity of the modified starch is reduced by acid, enzymes, chlorine, peroxide treatments or a combination thereof.

21. The cheese product of claim 13, wherein the modified starch comprises acetic anhydride substituted starch or starches with a maximum acetyl level of 2.5% bound to the starch.

22. The cheese product of claim 21, wherein the viscosity of the modified starch is reduced by acid, enzymes, chlorine, peroxide treatments or a combination thereof.

23. The cheese product of claim 13, wherein the cheese product is a processed cheese product.

24. The cheese product of any of claims 1-23, wherein the cheese product has and emulsification time of less than about 14 minutes.

25. The cheese product of any of claims 1-23, wherein the cheese product has an emulsification time in a range of about 10-14 minutes.

26. A food product comprising the cheese analogue product of claim 1.

27. A food product comprising the cheese analogue product of claim 11.

28. A food product comprising the cheese analogue product of claim 12.

29. A food product comprising the processed cheese product of claim 23.

30. A food product comprising the cheese product of claim 13.

31. The cheese product of claim 1, wherein the cheese product is a processed cheese product.
